(19) United States
(12) Patent Application Publication
(10) Pub. No.: US 2009/0006157 A1
(43) Pub. Date: Jan. 1, 2009

(54) SYSTEMS AND METHODS FOR DETERMINING THE LEVEL OF BEHAVIORAL CONCERN WITHIN A CORPORATE DISCLOSURE AND DISPLAYING THE DETERMINATION IN A BEHAVIORAL ASSESSMENT MATRIX

(76) Inventors: Roderick S. Carmody, Boston, MA (US); Philip R. Houston, Greenville, NC (US)

Correspondence Address: ROPES & GRAY LLP, PATENT DOCKETING 39/361, 1211 AVENUE OF THE AMERICAS, NEW YORK, NY, 10036-8704, US

(21) Appl. No.: 12/028,369

(22) Filed: Feb. 8, 2008

Related U.S. Application Data
(60) Provisional application No. 60/937,760, filed on Jun. 28, 2007.

(51) Int. Cl. G06Q 10/00; G06F 3/01

(52) U.S. Cl. 705/7

(57) ABSTRACT

A system and method for determining the level of behavioral concern and displaying the determination in a behavioral assessment matrix is disclosed. Determining the level of behavioral concern is based on the presence or absence of predetermined deceptive behaviors. The deceptive behaviors are identified within a transcript segment, categorized and indicators, representing the level of behavioral concern, are displayed in a behavioral assessment matrix.

### CLAIM TO EARLIER FILED RELATED PATENT APPLICATION

This application claims priority to an earlier filed provisional patent application 60/937,760, filed Jun. 28, 2007. This application is related to an earlier filed patent application Ser. No. 10/773,446, filed Feb. 5, 2004. Both of these applications are incorporated herein in their entirety.

### BACKGROUND OF THE INVENTION

The systems and methods described herein relate to identifying behavioral concerns within disclosures such as corporate disclosures. The systems and methods described herein also relate to presenting a summary of disclosures including behavioral concerns within a visual behavioral assessment matrix.

Corporate disclosures such as, for example, earnings conference calls, typically held by public companies to satisfy disclosure requirements to investors, are extremely valuable to analysts, advisors, and portfolio managers. In fact, according to a study by the CFA Institute, the demand for corporate earnings call transcripts is second only to SEC filings for sources of information provided by a public company. However, corporate disclosures have traditionally been analyzed only for the information contained explicitly therein.

Recent times have seen an upheaval in corporate governance and the scrutiny of disclosures by corporate officers relating to the financial health of their companies, their company's compliance with securities regulations and other matters. Investors and securities regulators are increasingly skeptical about disclosures made by such officers in interviews, written disclosures and in their corporate filings. Thus far, investors have not had accurate, reliable, or objective methods for assessing the veracity of such disclosures, which have too often turned out to be inaccurate. Investors have either accepted such disclosures on faith or have evaluated them on an ad hoc basis. Neither approach is satisfactory in light of the substantially increased risk from an investment decision based on inaccurate or misleading information.

Current methods of digesting information from disclosures (audio, video and text transcript) are extremely inefficient. Many earnings calls last over one hour in length with transcripts that run over 30 pages, making it difficult for investors to quickly gain a great deal from the information. Additionally, corporate calls are event driven based on, for example, merger or acquisition announcements, that can happen at any time. As such, methods and systems that organize, summarize, and analyze earnings conference calls are therefore highly desirable.

Accordingly, there is a significant need for a reliable and practical method of identifying behavioral concerns such as potentially deceptive disclosures or statements, or lack thereof, within disclosures by corporate officers relating to the financial position and overall status of their companies. With the advent of computer systems that can carry robust applications, there is an opportunity to streamline the method of identifying deceptive behaviors in disclosures and providing a more efficient and informative platform for assessing this information using an interactive application.

### SUMMARY OF THE INVENTION

The systems and methods described herein relate to identifying behavioral concerns within disclosures. Disclosures may be corporate disclosures, such as earnings conference calls. The disclosures may contain stimuli and responses. A stimulus may be, for example, a question presented and a response may be, for example, an answer to the question presented.

The system described herein in one embodiment provides a computer-based system and method for generation of a visual behavioral assessment matrix. The system takes information contained in a disclosure, parses it into discrete transcript segments, labels the transcript segment with predetermined identifiers, summarizes the transcript segment, and analyzes the transcript segments for deceptive behaviors.

The stimuli and associated responses are reviewed to determine whether a cluster of deceptive behaviors is exhibited in response to stimuli. A cluster of deceptive behaviors may be, for example, two or more deceptive behaviors present in a response to a question.

Once a cluster of deceptive behavior is identified the deceptive behaviors within the cluster are assigned into categories. Categories may include one of: an act of information concealment (“conceal”); an intent to manage the perception of information (“convince”); an effort to mislead or intimidate (“attack”); a management of the disclosure process (“control”); and an act that is reactive but non-verbal (“react”).

Levels of behavioral concern may be determined for each cluster. Levels of behavioral concern may be determined, based on the categories of deceptive behavior within the cluster. In determining a level of concern for the cluster, the different categories of behaviors may be weighted differently thereby associating a higher level of behavioral concern with some categories than with other categories. Levels of behavioral concern may also be determined based on the number of deceptive behaviors within the cluster. Stimulus attributes may also be a factor in determining levels of behavioral concern. Finally, levels of behavioral concern may be determined based on a level of deceptiveness of the deceptive behaviors within the cluster. The determined levels of behavioral concern may then be graphically represented and displayed in a visual behavioral assessment matrix, thereby giving an investor a visual overview of those areas of concern of the conference call without having to laboriously read through and analyze it.

Stimuli and responses contained within the corporate disclosure, such as a conference call, are potential indicators that may be plotted in the assessment matrix. The user can get an overall sense of the conference call by glancing over the behavioral assessment matrix. If, for example, there are many plotted indicators in the high level of behavioral concern, this indicates to the user that there are deceptive behaviors present in the conference call and consequently there may be risk in the investment to the extent the disclosure is not complete or reliable. Conversely, if, for example, most of the indicators are in the low level of behavioral concern, this indicates to the user that there is less such risk. The system will show a screen of indicators the user may view based on what is contained within the disclosure.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative user equipment device that may be used to provide an interactive behavioral assessment matrix in accordance with some embodiment of the invention;

FIG. 2 is a diagram of an illustrative system environment that may be used to determine levels of deceptive behavior and provide an interactive behavioral assessment matrix in accordance with some embodiment of the invention;

FIGS. 3-7 show illustrative behavioral assessment matrix display screens that may be provided in accordance with some embodiments of the invention; and

FIGS. 8-10 are illustrative process flowcharts of steps involved in determining levels of behavioral concern and displaying a behavioral assessment matrix according to some embodiments of the invention.

### DETAILED DESCRIPTION OF THE PREFERRED EMBODIMENTS

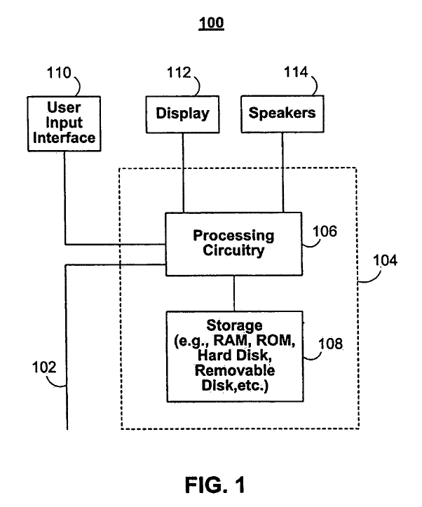

FIG. 1 shows a generalized embodiment of illustrative user equipment device 100 on which a visual assessment matrix may be provided. User equipment device 100 may receive data via input/output path 102. I/O path 102 may provide data to control circuitry 104, which includes processing circuitry 106 and storage 108. Control circuitry 104 may be used to dedicate space on and direct recording of information to storage devices (e.g., storage 108), and direct displaying of information on display devices (e.g. display 112). Control circuitry 104 may be used to send and receive commands, requests, and other suitable data using I/O path 102. I/O path 102 may connect control circuitry 104 (and specifically processing circuitry 106) to one or more communications paths (described below). I/O functions may be provided by one or more of these communications paths, but are shown as a single path in FIG. 1 to avoid overcomplicating the drawing.

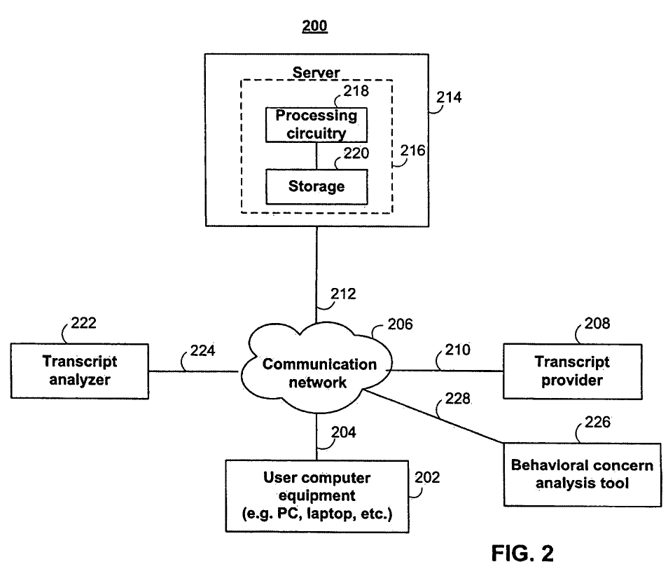

Control circuitry 104 may be based on any suitable processing circuitry 106 such as one or more microprocessors, microcontrollers, digital signal processors, programmable logic devices, etc. In some embodiments, control circuitry 104 executes instructions for a behavioral assessment matrix application stored in memory (i.e., storage 108). Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 2).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 108 that is part of control circuitry 104. Storage 108 may include one or more of the above types of storage devices. For example, user equipment device 100 may include a hard drive and a portable data storage as a secondary storage device. Storage 108 may be used to store various types of media described herein and behavioral assessment matrix application data, including corporate disclosure information, behavioral assessment matrix application settings, user preferences or profile information, or other data used in operating the behavioral assessment application. Nonvolatile memory may also be used (e.g., to launch a boot-up routine and other instructions).

A user may control circuitry 104 using user input interface 110. User input interface 110 may be any suitable user interface, such as a remote control, mouse, trackball, keypad, keyboard, touch screen, touch pad, stylus input, joystick, voice recognition interface, or other user input interfaces. Display 112 may be provided as a stand-alone device or integrated with other elements of user equipment device 100. Display 112 may be one or more of a monitor, a television, a liquid crystal display (LCD) for a mobile device, or any other suitable equipment for displaying visual images. Speakers 114 may be provided as integrated with other elements of user equipment device 100 or may be stand-alone units. The audio component of videos and other media content displayed on display 112 may be played through speakers 114.

User equipment device 100 of FIG. 1 can be implemented in system 200 of FIG. 2 as user computer equipment 202. User equipment devices, on which a behavioral assessment matrix application is implemented, may function as a standalone device or may be part of a network of devices.

In system 200, there is typically more than one of each type of user equipment device but only one of each is shown in FIG. 2 to avoid overcomplicating the drawing. In addition, each user may utilize more than one type of user equipment device (e.g., a user may have two personal computers, one at home and one at work) and also more than one of each type of user equipment device (e.g., a user may have a laptop and personal computer).

The user may also set various settings to maintain consistent behavioral assessment matrix application settings across in-home devices and remote devices. Settings include those described herein, as well as preferences that the behavioral assessment matrix application utilizes to make recommendations, display preferences, and other desirable guidance settings. For example, if a user sets a display configuration on, for example, their personal computer at their office, the same channel would appear as a favorite on the user's in-home devices (e.g., user computer equipment). Therefore, changes made on one user equipment device can change the behavioral assessment matrix experience on another user equipment device, regardless of whether they are the same or a different type of user equipment device.

The user equipment device may be coupled to communications network 206. Namely, user equipment 202 is coupled to communications network 206 via communications paths 204. Communications network 206 may be one or more networks including the Internet, a mobile phone network, mobile device network, cable network, public switched telephone network, or other types of communications network or combinations of communications networks. Path 204 may separately or together include one or more communications paths, such as, a satellite path, a fiber-optic path, a cable path, a path that supports Internet communications (e.g., IPTV), or any other suitable wired or wireless communications path or combination of such paths.

System 200 includes transcript provider 208, connected to communication network 206 via communication path 210, remote server 214 that contains control circuitry 216, processing circuitry 218 and storage 220, transcript analyzer 222 connected to communication network 206 via communication path 224, and behavioral concern analysis tool 226 connected to communication network 206 via communication path 226. Communications with the transcript provider 208, remote server 214, transcript analyzer 224, and behavioral concern analysis tool 226 may be exchanged over one or more communications paths, but are shown as a single path in FIG. 2 to avoid overcomplicating the drawing. In addition, there may be more than one of each of transcript provider 208, remote server 214, transcript analyzer 222, and behavioral concern analysis tool 226, but only one of each is shown in FIG. 2 to avoid overcomplicating the drawing. (The different types of each of these sources are discussed below.) If desired, transcript provider 208, remote server 214, transcript analyzer 222, and behavioral concern analysis tool 226 may be integrated on one device, e.g., remote server 214 or user equipment 202. Although communications between transcript provider 208, remote server 214, transcript analyzer 222, behavioral concern analysis tool 226 and user equipment device 202 are shown as through communications network 206, in some embodiments, they may communicate directly via communication paths (not shown) such as those described above in connection with paths 204, 210, 212, and 224.

Transcript provider 208 may include one or more types of data distribution equipment including a disclosure distribution facility, a disclosure server, Internet providers, and other corporate disclosure content providers. Transcript provider 208 may be the originator of disclosures (e.g., a transcript providing service, internet simulcast provider, etc.) or may be storage facility for prerecorded, preloaded disclosure content. In some embodiment, transcript provider 208 may have a local storage (not shown) that can save the records of disclosures. In other embodiments, records may be stored on remote storage 220. In yet another embodiment, transcript provider 208 can act as a conduit for the disclosures. This embodiment is appropriate where the disclosures are received via continuous feed from a disclosure distribution facility.

Remote server 214 contains control circuitry 216 which includes processing circuitry 218 and storage 220. Control circuitry of remote server 214 may be used to send and receive commands, requests, and other suitable data, dedicate space on and direct recording of information to storage devices, and direct displaying of information on display devices. Control circuitry of remote server 214 may be based on any suitable processing circuitry 218 such as processing circuitry based on one or more microprocessors, microcontrollers, digital signal processors, programmable logic devices, etc. In some embodiments, control circuitry of remote server 214 executes instructions for a behavioral assessment matrix application stored in memory (i.e., storage 220).

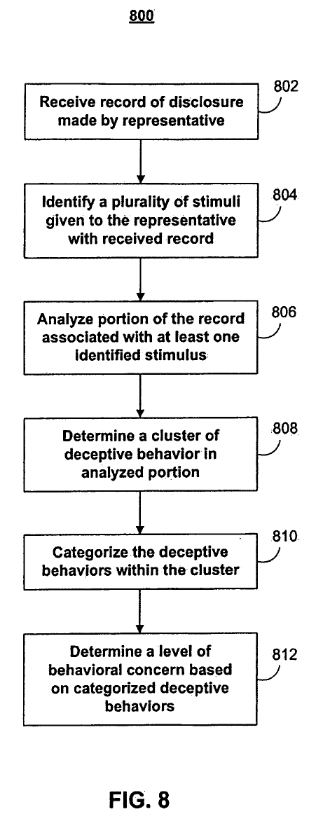

Transcript analyzer 222 can retrieve transcripts for behavioral concern analysis from transcript provider 208 via communication paths 224 and 210. The retrieved transcripts may be parsed into transcript segments and analyzed to identify deceptive behaviors within the transcript segments. Each of the identified deceptive behaviors may then be categorized into one or more categories of deceptive behaviors. In addition to deceptive behaviors, other behavioral concerns may be identified, such as sentiment of a transcript segment as indicated by analysts' questions and responses made by corporate representatives. The different types of behavioral concerns may be displayed together, merged into a single behavioral concern level or separately provided. The operation of transcript analyzer may be at least in part automated or semi-automated or may be at least in part manually controlled by a transcript analysis user. A more detailed description of the operation of transcript analyzer 222 is provided below with respect to the flow charts of FIGS. 8-10.

Behavioral concern analysis tool 226 can retrieve the disclosure, identified deceptive behaviors, and categorizations of deceptive behaviors from transcript analyzer 222 via communication paths 224 and 210. The behavioral concern analysis tool 226 analyzes the identified deceptive behaviors and categorizations of deceptive behaviors, and determines levels of behavioral concerns for the deceptive behavior. The operation of transcript analyzer may be at least in part automated or semi-automated or may be at least in part manually controlled by a transcript analysis user. A more detailed description of the operation of behavioral concern analysis tool 226 is provided below with respect to the flow charts of FIGS. 8-10.

The behavioral assessment matrix application, residing on server 214 or user equipment 202, retrieves the level of deceptive behavior data and displays it on display 112.

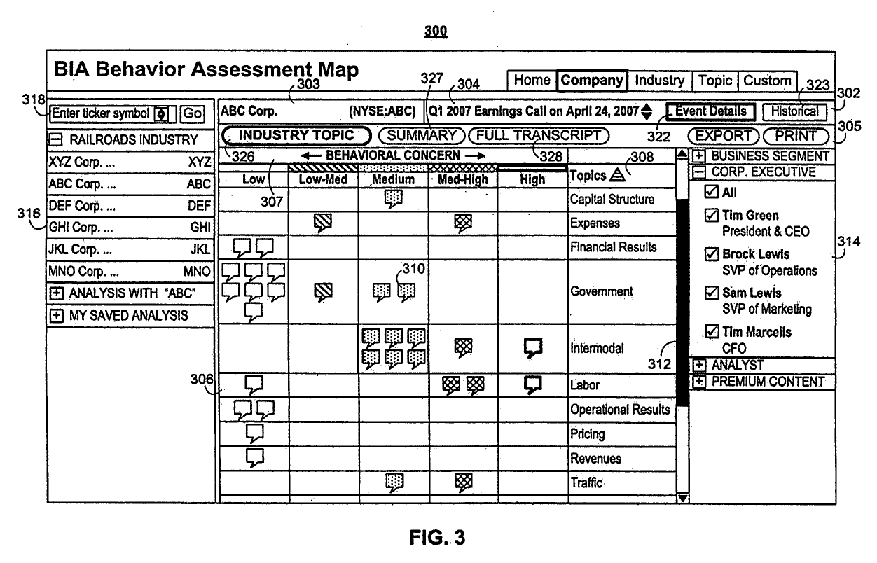

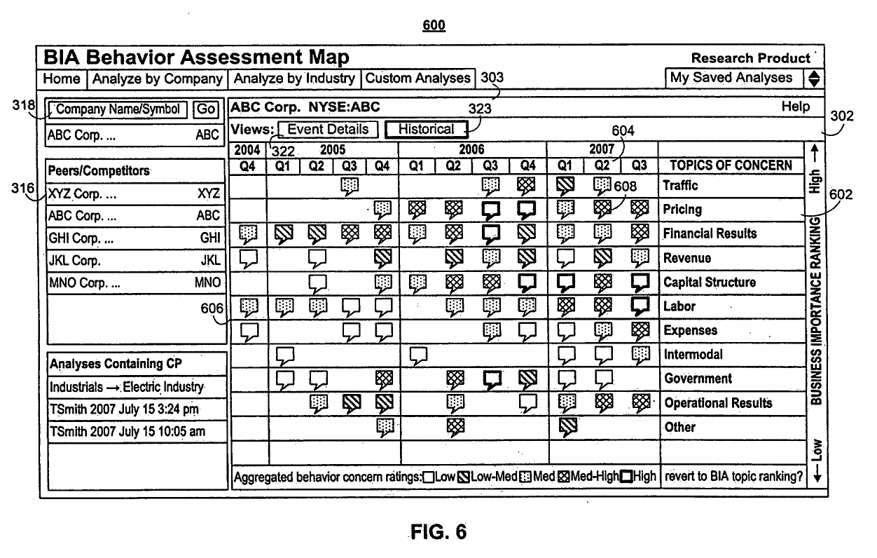

FIG. 3 shows an illustrative interactive behavioral assessment matrix application screen that may present a graphical indication of identified levels of behavioral concern in a corporate disclosure. This screen may be provided on display 112 (FIG. 1) of user equipment 204 (FIG. 2). In particular, FIG. 3 shows an illustrative behavioral assessment matrix application screen 300 that includes header region 302 with header identifier regions 303 and 304, sub-header region 305, behavioral assessment matrix 306 that includes concern level axis 307, topic axis 308, indicator 310, scroll lever 312, representative field 314, competitor field 316 and input box 318. Header region 302 displays identifier region 303, that shows what company the behavioral assessment matrix 306 renders, and identifier region 304, that shows what corporate disclosure the behavioral assessment matrix 304 is representing and on what date the disclosure occurred. In this example, the behavioral assessment matrix 306 represents the earnings call for ABC Corp. concerning the first quarter of 2007. Header region 302 may also include, for example, event details button 322 and historical button 323 that allow the user to navigate from the behavioral assessment matrix 306 to the history matrix 606 (FIG. 6) (detail discussion below) and vice versa.

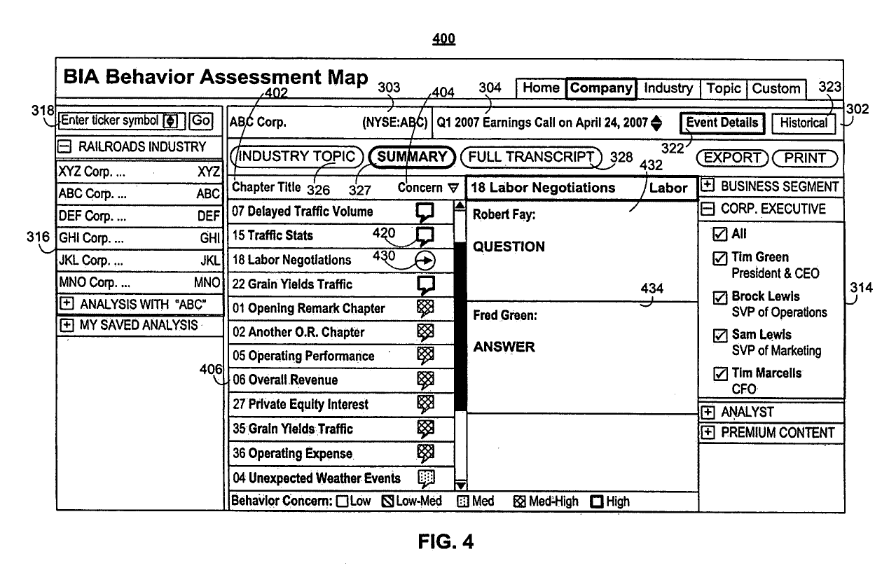

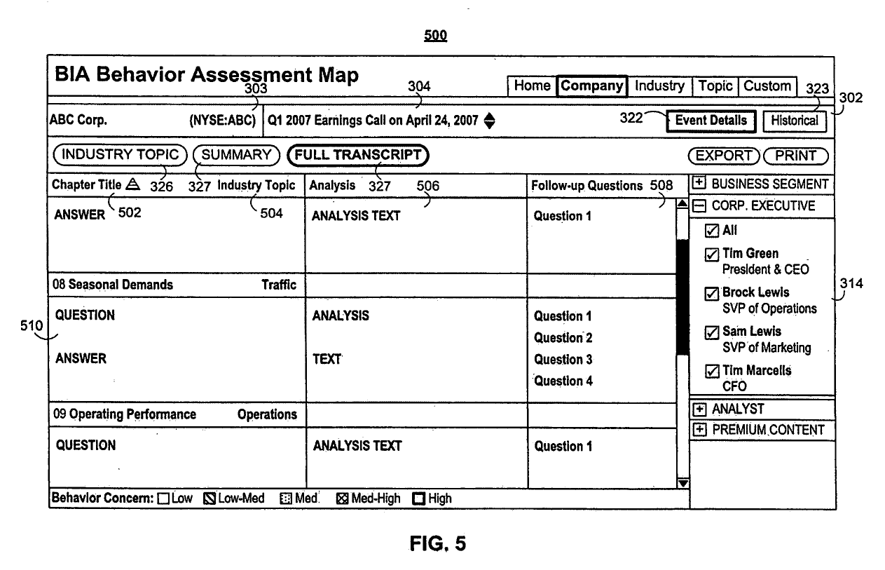

Sub-header region 305 may contain industry topic button 326, question summary 327 and full transcript button 328, which allow users to navigate from the behavioral assessment matrix 306 to the chapter display 406 (FIG. 4) and full transcript display 506 (FIG. 5). For example, if the user, after analyzing the behavioral concerns contained within a earnings call, wants to read the transcript of the earnings call, the user can select question summary 327. Selecting question summary 327 may navigate the user to behavioral assessment matrix application display 400 (FIG. 4). Further, selecting full transcript button 328 may navigate the user to behavioral assessment matrix application display 500 (FIG. 5).

Behavioral assessment matrix 306 displays corporate disclosures that have been analyzed by behavioral concern analysis tool 226 (FIG. 2) and given levels of concern to clusters of deceptive behavior. Concern level axis 307 resides on the x axis of behavioral assessment matrix 306 and topic axis 308 resides on the y axis. Topic axis 308 is populated with topics concerning the specific disclosure currently being viewed, as determined by transcript analyzer 222. The more leftmost on concern level axis 307, the lower the level of concern present in the cluster of deceptive behavior and at the extreme, the absence of a cluster of deceptive behavior. Conversely, the more rightmost on concern level axis 307, the higher the level of concern present in the cluster of deceptive behavior. Indicator 310 represents a discrete textual segment from a disclosure that may or may not contain deceptive behavior (depending on the color or design of the indicator). In this example, user entered “ABC” in input box 318. Processing circuitry 106 (FIG. 1), using a behavioral assessment matrix application, retrieves transcript data from transcript analyzer 222 and levels of behavioral concerns from behavioral concern analysis tool 226 and generates behavioral assessment matrix 306. Indicator 310, generated based on level of concern data retrieved from behavioral concern analysis tool 226, concerns a topic related to “Government” and is of medium concern. This indicates to the user, worried about investing in ABC Corp. because of governmental concerns, that there is only a medium level of deceptive behavior present in responses dealing with the government. The user can also get a quick sense of the reliability and completeness of ABC Corp. by glancing over the behavior assessment matrix. If there are more high level concerns in subject important to the user, this indicates that there may be a higher level of risk in this investment. If there are more low level concerns there may be less risk.

In some embodiments, the data represented in the x axis can be a totality of the behavioral concern, different types of behavioral concern such as deceptive behavior or sentiment that make up the totality of the behavioral concern, or individual bases for the behavioral concern. For example, sentiment may be the individual basis for the level of behavioral concern shown in concern level axis 307. The more negative the sentiment apparent in the stimulus associated with topic axis 308, the more rightmost indicator 310 is be placed in behavioral assessment matrix 306. Conversely, the more positive the sentiment apparent in the stimulus, the more leftmost indicator 310 is plotted in behavioral assessment matrix 306. In other embodiments, the user may select what makes up the level of behavioral concern shown in behavioral assessment matrix 306. For example, the user may want to only see sentiment apparent in the stimulus or a specific cluster of deceptive behaviors present in the transcript segment. Depending on what the user selected to be plotted in behavioral assessment matrix 306, indicator 310 would represent only that which the user selected.

In one embodiment, indicator 310 may be color or design coded for easier discernment. For example, all indicators of higher concern are colored red and of lower concern are colored green. Alternatively, as shown in behavioral assessment matrix 306, all indicators of higher concern are patterned bold and ones of lower concern are patterned blank.

The user can select or highlight indicator 310 using user input interface 110 (e.g., the user may mouse over the indicator). This may, for example, bring up a pop up window with a portion of the disclosure that leads to the behavioral concern analysis determination. This information may also include, for example, analysis information, weight value given to each deceptive behavior, categorization information, etc. Topics, in topic axis 308, can be moved, so that the topics of interest are on top. This can be accomplished by clicking on a topic within topic axis 308, and dragging the topic to the desired location. This can be repeated until the desired topics display is visible in topic axis 308. Alternatively, scroll lever 312 may be dragged up and down to view the desired topics. Topics in topic axis 308 may be listed, for example, based on user preferences learned on previous sessions, transcript analyzer 222's designation based on this disclosure (e.g., all topics covered by a earnings conference call), or by a manual procedure (technician trained to identify topics in a disclosure).

Representative field 314 allows users to select what data should be displayed in behavioral assessment matrix 306. For example, if the user only wants to see levels of deceptive behavior presented by a particular representative, such as the CEO, the user can deselect all the checkboxes in representative field 314 except the one next to “Tim Green.” Additionally, if the user wants to compare the deceptive behavior present in a competitor's earnings conference call, the user may select a competitor company checkbox from competitor field 316, which may populate behavioral assessment matrix 306 with indicators relating to the earning conference call of the company selected.

In some embodiments, the behavioral assessment matrix 306 can be generated to include multiple disclosures on the same matrix. For example, the behavioral assessment matrix 306 displays disclosure information for two conference calls in successive quarters. The user can view the level of behavioral concern for multiple quarters to determine, for example, the direction of deceptive behavior. In other embodiments, the behavioral assessment matrix 306 can provide the trend analysis for the selected quarters.

In some embodiments, behavioral assessment matrix 306 can be individualized to show a screen that lists the users past behavior concern analysis entries. For example, behavioral assessment matrix 306 allows the user to save past behavioral concern analyses for later view. When the user enters the name of a company in input box 316, a list may be automatically saved showing all the past analyses the user has asked for over a certain amount of time. The user may also view past entries to form individualized trends based on previous entries.

FIG. 4 shows an illustrative interactive behavioral assessment matrix application display screen that may be provided to present a question summary of a corporate disclosure. This screen may be displayed on display 112 (FIG. 1) of user equipment 204 (FIG. 2). In particular, FIG. 4 shows an illustrative behavioral assessment matrix application display 400 that includes chapter title header 402 containing concern header 404, chapter display 406, indicator 420, arrow 430, question box 432 and answer box 434. Chapter title header 402 may, for example, list the chapter topics. Concern header 404 may, for example, list indicators. In this example, the user selected the question summary 327 (FIG. 3). Processing circuitry 106, using a behavioral assessment matrix application, retrieves chapter information and transcript data from transcript analyzer 222 and levels of behavioral concern data from behavioral concern analysis tool 226. Processing circuitry 106 generates behavioral assessment matrix application display 400 using the retrieved information. The chapters are listed in descending order starting from high level concerns to lower level concerns under title header 402. The user can change the order from descending to ascending by clicking on the arrow in the concern header 404, using user input interface 110.

The user is also able to click on any of the indicators under the concern header 404. In this example, the user clicked on indicator next to “18 Labor Negotiations.” The indicator turns into an arrow 430, indicating that information relating to the question summary selected is displayed to the right and question box 432 and answer box 434 appear. Question box 432 displays the question relating to labor negotiations and answer box 434 displays the corresponding answer.

FIG. 5 shows an illustrative interactive behavioral assessment matrix application display screen that may be provided to present a full transcript of a corporate disclosure. This screen may be displayed on display 112 (FIG. 1) of user equipment 204 (FIG. 2). In particular, FIG. 5 shows an illustrative behavioral assessment matrix application display 500 that includes question summary header 502 containing industry topic header 504, analysis box 506, follow-up question box 508, and question and answer box 510. Question summary header 502 may, for example, list the chapter topics. Concern header 504 may, for example, list industry topic for the viewed chapter. Analysis box 506 contains any analysis concerning the question and associated answer within question and answer box 510. Follow-up question box 508 contains any follow-up questions concerning the question and associated answer within question and answer box 510. In this example, the user selected the full transcript button 328 (FIG. 3). Processing circuitry 106, using a behavioral assessment matrix application, retrieves chapter information and transcript data from transcript analyzer 222 and analysis data from behavioral concern analysis tool 226. Processing circuitry 106 generates behavioral assessment matrix application display 500 using the retrieved information. The questions are listed in ascending order starting from the first question until the last under question summary header 502. The user can change the order from ascending to descending by clicking on the arrow in the chapter title header 502, using user input interface 110.

FIG. 6 shows an illustrative interactive behavioral assessment matrix application display screen that may be provided to present a graphical indication of levels of deceptive behavior that may be present in historical corporate disclosures. This screen may be displayed on display 112 (FIG. 1) of user equipment 204 (FIG. 2). In particular, FIG. 6 shows an illustrative behavioral assessment matrix application display 600 that includes topics label 602, time period header 604, historical behavioral assessment matrix 606, and aggregated indicator 608. Aggregated indicator 608 represents the highest concern mapped to that topic. In this example, the historical behavioral assessment matrix 606 represents historical earning calls for ABC Corp. Processing circuitry 106, using a behavioral assessment matrix application, retrieves transcript data from transcript analyzer 222 and analysis data from behavioral concern analysis tool 226. Processing circuitry 106 generates behavioral assessment matrix application display 600 using the retrieved information. The first earnings call displayed is from the fourth quarter of 2004 and the last earnings call is from the third quarter of 2007, as shown in time period header 604. Topics label 602 relates to “Pricing” and aggregated indicator 608 depicts the aggregated level of behavioral concern for that quarter. This gives a user an efficient way to glance at the behavioral assessment matrix application display and get a sense if the company is highly deceptive and therefore an investment that may present more risk.

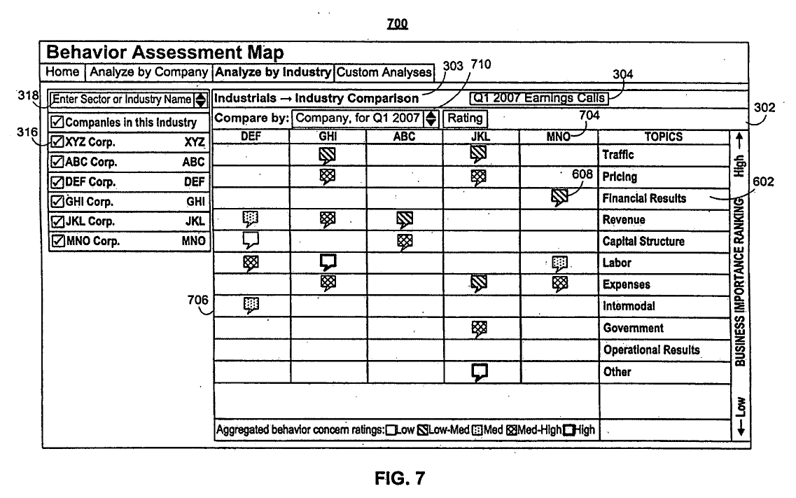

FIG. 7 shows an illustrative interactive behavioral assessment matrix application display screen that may be provided to present a side by side graphical indication of levels of deceptive behavior of two or more companies. This screen may be displayed on display 112 (FIG. 1) of user equipment 204 (FIG. 2). In particular, FIG. 7 shows an illustrative behavioral assessment matrix application display 700 of a comparison of competing companies and that includes competitor header 704, competitor assessment matrix 706 and time input box 710. In this example, the competitor behavioral assessment matrix 606 represents a side by side visual display of relevant competitors to ABC Corp. Processing circuitry 106, using a behavioral assessment matrix application, retrieves transcript data from transcript analyzer 222 and analysis data from behavioral concern analysis tool 226 for a group of competitors in the same industry as ABC Corp. Competitors may be selected, for example, based on the competitors in competitors list 316. Processing circuitry 106 generates behavioral assessment matrix application display 700 using the retrieved information. The user may enter the appropriate disclosure, e.g., earnings conference call for comparison in time input box 710 using user input interface 110. In this example, the user entered the first quarter of 2007. Topics label 602, in this example relates to “Financial Results” and aggregated indicator 608 depicts the aggregated level of behavioral concern for that competitor. This gives a user a effecient way to glance at the behavioral assessment matrix application display and get a sense if the company is highly deceptive and therefore an investment with potentially more risk than its competitors.

FIGS. 8-10 are illustrative process flow charts of steps involved in determining levels of behavioral concern and displaying a behavioral assessment matrix reflecting those determinations. In particular, FIG. 8 shows an illustrative process 800 for determining levels of behavioral concern, in accordance with one embodiment of the current invention. In step 802, transcript analyzer 222 retrieves a disclosure from transcript provider 208. In step 804, transcript analyzer 222 identifies a plurality of stimuli given to the representative within the record. A stimulus might be the beginning of the declaration, a change in topics or the beginning of a statement. In steps 806 and 808, transcript analyzer 222 analyzes a portion of the record associated with at least one identified stimulus for a cluster of deceptive behavior. A cluster of deceptive behavior is, for example, at least two of the following present in the portion of the record, i.e. the response to the stimulus: failure to respond substantively to a question during an interview; repeating all or a portion of the question; giving an unnecessarily and overly specific answer to a question; expressing an inappropriate level of concern for an issue or topic raised by a stimulus; responding to a stimulus by making verbal attacks directed at the interviewer or another party; using qualifying language in response to the stimulus; invoking religion or other moral authorities to emphasize the purported integrity of an answer; failure to understand simple or well-known terms, concepts or questions; using phrases intended to indicate an incomplete or uncertain memory; being excessively courteous; complaining about the subject matter of the stimulus, or the interview in general; stating that they are reluctant or unwilling to answer a question; asking inappropriate or out of place questions in response to a question; and responding to the question with a protest or convincing statement, rather than with the responsive, factual information requested. If, for example, only one deceptive behavior is present in the response to the stimulus, transcript analyzer 222 may regard that portion of the record as complete and reliable. However, if at least two deceptive behaviors are present, a cluster of deceptive behavior is present.

At step 810, transcript analyzer 222 categorizes the deceptive behaviors as one of an act of information concealment (“conceal”); an intent to manage the perception of information (“convince”); an effort to mislead or intimidate (“attack”); a management of the disclosure process (“control”); and an act that is reactive but non-verbal (“react”). At step 812, transcript analyzer 222 transmits the deceptive behaviors and transcript segments to behavioral concern analysis tool 226, which determines a level of behavioral concern for each cluster of deceptive behaviors, such as, for example, low, medium and high. The level of behavioral concern for each cluster is determined based on one of the levels of behavioral concern for each deceptive behavior. In some embodiments the level is based on the number of behaviors. For example, if two deceptive behaviors attempt to “conceal” important information and two deceptive behaviors attempt to “convince” the stimulus provider, those four deceptive behaviors form a cluster and may be deemed a higher level of deceptive behavior than only a cluster of two acts of concealment. For example, a cluster of four acts of deceptive behavior may be a medium level of deceptive behavior while the cluster of two deceptive behaviors may only be a low level of deceptive behavior. In some embodiments, each deceptive behavior carries its own weight and is determined accordingly. In such an embodiment, the categories of the behaviors may be weighted differently thereby associating a higher level of behavioral concern with some categories than with other categories. In such an embodiment, the number of deceptive behaviors is not determinate of how the levels are designated. For example, there may be instances that fewer deceptive behaviors in a cluster may be designated a higher level of concern than a cluster with more deceptive behaviors because of the nature of the deceptive behaviors within the less numerous cluster. In some embodiments, combinations of deceptive behaviors may be more determinative than the number of deceptive behaviors or the nature of individual deceptive behaviors. For example, four deceptive behaviors categorized as “control” and “react,” may be determined to have a lower level of deception behavior than two deceptive behaviors categorized as “convince” and “attack.” In yet other embodiments, stimulus attributes may determine the level of behavioral concern. For example, a stimulus regarding a past event such as for example, a question about the integrity of the company's past accounting practices, that has a cluster of deceptive behaviors associated with it may map to a higher level of behavioral concern than a stimulus regarding a future event such as for example, a question about where the direction of the stock price is headed.

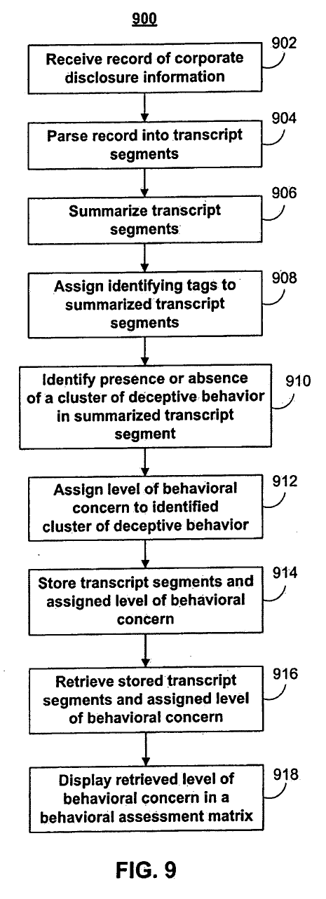

FIG. 9 shows an illustrative process 900 for displaying levels of behavioral concern in behavioral assessment matrix, in accordance with one embodiment of the current invention. In step 902, transcript provider 208 receives a record of disclosure information. In step 904, transcript provider 208 parses the received record into discrete transcript segments. A parsed transcript segment may be, for example, a discrete question and answer segment, a question by an interviewer, an answer by a particular representative, or a particular section of the record, such as the opening remarks. In step 906 and 908, the transcript provider 208 transmits the transcript segments to transcript analyzer 224. Transcript analyzer 224 summarizes the transcript segments and assigns identifying tags to each summarized transcript segment. Assigning identity tags may be, for example, assigning industry topic for topic x axis 308. In step 910, the transcript analyzer 224 identifies the presence or absence of a cluster of deceptive behaviors. If only one deceptive behavior is present in the response to the stimulus, transcript analyzer 222 regards that portion of the record as complete and reliable. If at least two deceptive behaviors are present then a cluster of deceptive behavior is present. Transcript analyzer 222 categorizes the deceptive behaviors into one or more categories such as the categories described above. Once transcript analyzer 222 categorizes the deceptive behaviors in the cluster, in step 912, transcript analyzer 222 transmits the categorized deceptive behaviors to behavioral concern analysis tool 226, which determines a level of behavioral concern based on the received categorized deceptive behaviors.

In step 914, behavioral concern analysis tool 226 stores transcript segments and levels of behavioral concern data in storage 108 or remote storage 220. When processing circuitry 108, using a behavioral assessment matrix application, detects a user input, processing circuitry 108 retrieves the transcript segments and level of behavioral concern data from storage 220 (step 916) and displays the data in a behavioral assessment matrix display (step 918).

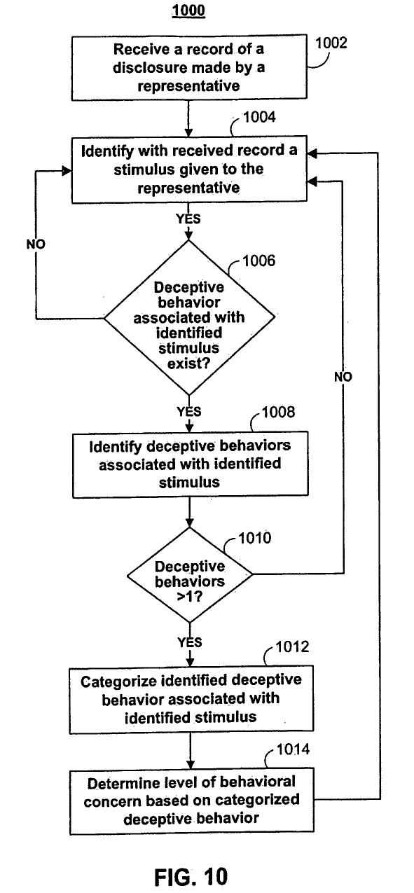

FIG. 10 shows an illustrative process flowchart 1000 of steps involved in determining levels of behavioral concern. In step 1002, transcript analyzer 222 retrieves the corporate disclosure from transcript provider 208. In step 1004, transcript analyzer 222 identifies a plurality of stimuli given to the representative within the record. A stimulus might be the beginning of the declaration, a change in topics or the beginning of a statement. In steps 1006, transcript analyzer 222 determines if any deceptive behaviors are associated with the identified stimulus. If there are no deceptive behaviors associated with the stimulus, transcript analyzer 222 identifies another stimulus given to the representative in the disclosure (step 1004).

If there are deceptive behaviors associated with the stimulus, in step 1008, transcript analyzer 222 identifies those deceptive behaviors. In step 1010, the transcript analyzer determines if the number of deceptive behaviors associated with the stimulus is greater than one, thus creating a cluster of deceptive behavior.

If the number of deceptive behaviors is not greater than one, a cluster of deceptive behavior is not present in this section of the disclosure and transcript analyzer 222 identifies another stimulus given to the representative and determines if there are any deceptive behaviors associated with the identified stimulus (steps 1004 and 1006). If the number of deceptive behaviors is greater than one, in step 1012, transcript analyzer 222 categorizes each deceptive behavior within the cluster of deceptive behaviors. In step 1014, transcript analyzer 222 transmits the deceptive behaviors and transcript segments to behavioral concern analysis tool 226, which determines a level of behavioral concern based on the received categorized deceptive behaviors.

The above described embodiments of the present invention are presented for purposes of illustration and not of limitation, and the present invention is limited only by the claims which follow.

What is claimed is:

1. A method for displaying a level of behavioral concern within a corporate disclosure in an interactive visual behavioral assessment matrix, comprising:
receiving a corporate disclosure record;
parsing the corporate disclosure record into a plurality of discrete transcript segments;
determining a level of behavioral concern for at least one of the transcript segments; and
displaying the at least one transcript segment in an interactive visual behavioral assessment matrix with an indication of the determined level of behavioral concern.

2. The method in claim 1, wherein parsing the corporate disclosure record into the discrete transcript segments further comprises labeling the transcript segments with predetermined identifiers.

3. The method in claim 1, wherein determining a level of behavioral concern for the at least one transcript segment further comprises:
identifying the presence or absence of at least two deceptive behaviors present in the at least one transcript segment; and
determining a level of behavioral concern for the at least two identified deceptive behaviors.

4. The method of claim 1, wherein determining a level of behavioral concern for the at least one transcript segment further comprises:
identifying within the at least one transcript segment a stimulus given to the representative;
analyzing a portion of the at least one transcript segment associated with the stimulus to determine the presence or absence of a cluster of deceptive behavior associated with the stimulus;
assigning a category to each of the deceptive behaviors within the cluster of deceptive behaviors associated with the stimulus; and
determining a level of behavioral concern for the categorized cluster of deceptive behaviors associated with the stimulus.

5. The method of claim 4, wherein the level of behavioral concern for the categorized cluster of deceptive behaviors associated with the stimulus is determined based on at least one of: the number of deceptive behaviors within the cluster, the categories assigned to each of the deceptive behaviors within the cluster, the stimulus attributes, and a level of deceptiveness of each of the deceptive behaviors within the cluster.

6. The method of claim 4, wherein the stimulus comprises a question posed to the representative.

7. The method of claim 4, wherein the deceptive behavior comprises a verbal or non-verbal response to the stimulus.

8. The method of claim 4, wherein assigning a category to each of the deceptive behaviors within the cluster comprises categorizing the deceptive behaviors as at least one of: an act of information concealment, an intent to manage the perception of information, an effort to mislead or intimidate, a management of the disclosure process, and an act that is reactive but is non-verbal.

9. The method of claim 1, wherein displaying the at least one transcript segment in an interactive visual behavioral assessment matrix with an indication of the determined level of behavioral concern comprises assigning an indicator to represent a level of behavioral concern assigned to a cluster of deceptive behaviors associated with the at least one transcript segment.

10. The method of claim 1, further comprising:
identifying a plurality of clusters of deceptive behaviors within the at least one transcript segment;
determining a level of behavioral concern for each of the plurality of clusters;
displaying in the interactive visual behavioral assessment matrix a plurality of indicators, wherein each indicator represents a level of behavioral concern determined for a cluster associated that indicator.

11. The method of claim 10, further comprising sorting the plurality of indicators displayed in the behavioral assessment matrix.

12. The method of claim 10, further comprising filtering the plurality of indicators displayed in the behavioral assessment matrix to display only a subplurality of the indicators.

13. A system for displaying a level of behavioral concern within a corporate disclosure in an interactive visual behavioral assessment matrix, comprising:
a user input device;
a display device; and
control circuitry comprising memory and processing circuitry, the control circuitry configured to:
receive a corporate disclosure record;
parse the corporate disclosure record into a plurality of transcript segments;
determine a level of behavioral concern for at least one of the transcript segments; and
display the at least one transcript segment in an interactive visual behavioral assessment matrix with an indication of the determined level of behavioral concern.

14. The system in claim 13, wherein the control circuitry configured to parse the corporate disclosure record into the transcript segments is further configured to label the transcript segments with predetermined identifiers.

15. The system in claim 13, wherein the control circuitry configured to determine a level of behavioral concern for the at least one transcript segment is further configured to:
identify the presence or absence of at least two deceptive behavior in the at least one transcript segment; and
determine a level of behavioral concern for the at least two identified deceptive behavior.

16. The system of claim 13, wherein the control circuitry configured to determine a level of behavioral concern for the at least one transcript segment is further configured to:
identify within the at least one transcript segment a stimulus given to the representative;
analyze a portion of the at least one transcript segment associated with the stimulus to determine the presence or absence of a cluster of deceptive behavior associated with the stimulus;
assign a category to each of the deceptive behaviors within the cluster of deceptive behavior associated with the stimulus; and
determine a level of behavioral concern for the categorized cluster of deceptive behavior associated with the stimulus.

17. The system of claim 16, wherein the level of behavioral concern for the categorized cluster of deceptive behaviors associated with the stimulus is determined based on at least one of: a number of the deceptive behaviors within the cluster, the categories assigned to each of the deceptive behaviors within the cluster, and a level of deceptiveness each of the of the deceptive behaviors within the cluster.

18. The system of claim 16, wherein the stimulus comprises a question posed to the representative.

19. The system of claim 16, wherein the deceptive behavior comprises a verbal or non-verbal response to the stimulus.

20. The system of claim 16, wherein the control circuitry configured to assign a category to each of the deceptive behaviors within the cluster is further configured to categorize the deceptive behaviors as at least one of an act of information concealment, an intent to manage the perception of information, an effort to mislead or intimidate, a management of the disclosure process, and an act that is reactive but are non-verbal.

21. The system of claim 11, wherein the control circuitry configured to display the at least one transcript segment in an interactive visual behavioral assessment matrix with an indication of the determined level of behavioral concern is further configured to assign an indicator to represent a level of behavioral concern assigned to a cluster of deceptive behaviors associated with the at least one transcript segment.

22. The system of claim 11, wherein the control circuitry is further configured to:
identify a plurality of clusters of deceptive behaviors within the at least one transcript segment;
determine a level of behavioral concern for each of the plurality of clusters;
display in the interactive visual behavioral assessment matrix a plurality of indicators, wherein each indicator represents a level of behavioral concern determined for a cluster associated that indicator.

23. The system of claim 11, wherein the control circuitry is further configured to sort the plurality of indicators displayed in the behavioral assessment matrix.

24. The system of claim 11, wherein the control circuitry is further configured to filter the plurality of indicators displayed in the behavioral assessment matrix to display only a subplurality of the indicators.
